(19) United States
(12) Patent Application Publication
(10) Pub. No.: US 2006/0153481 A1
(43) Pub. Date: Jul. 13, 2006

(54) Sensor assembly body, seal device, and rolling bearing device for motor vehicle

(75) Inventors: Minoru Sentoku, Osaka-shi, Osaka (JP); Shunichi Matsui, Osaka (JP); Masahiro Inoue, Osaka (JP); Yoshifumi Shige, Osaka (JP); Katsura Koyagi, Osaka (JP)

Correspondence Address: JORDAN AND HAMBURG LLP, 122 EAST 42ND STREET, SUITE 4000, NEW YORK, NY, 10168, US

(73) Assignee: Koyo Seiko Co., Ltd., Osaka-shi, Osaka (JP)

(21) Appl. No.: 10/545,274

(22) PCT Filed: Feb. 12, 2004
(86) PCT No.: PCT/JP04/01451

§ 371 Date: Aug. 10, 2005

(30) Foreign Application Priority Data
Feb. 12, 2003 (JP) 2003-33607
Feb. 12, 2003 (JP) 2003-33608

(51) Int. Cl. F16C 41/04

(52) U.S. Cl. 384/448

(57) ABSTRACT

A seal apparatus comprises an outer ring side seal ring fixed to an outer ring member, and an inner ring side seal ring fixed to an inner ring member. A pulser ring is fixed to a ring shaped core metal of the inner ring side seal ring. On an outer diameter side of the ring shaped core metal of the outer ring side seal ring, a magnetic sensor is molded with resin by an external member to be integrated therewith. A connector connected to the magnetic sensor is successively formed with the external member. A reinforcing member which reinforces the sensor side connector is provided on at least either of the external member or the sensor side connector.

### BACKGROUND OF THE INVENTION

The present invention relates to a rolling bearing apparatus for vehicles wherein a sensor and a pulser ring for detecting rotation used for ABS (anti lock brake system) or the like in automobiles are incorporated into a seal device known as a pack seal and a gap between inner and outer rings is sealed with this seal device with rotation detector incorporated therein. The invention also relates to a sensor assembly and seal device constituting the rolling bearing apparatus for vehicles.

In the related art, there has been proposed a rolling bearing apparatus for vehicles provided with a rotation detector (refer to, for example, Japanese Laid Open Patent Application Publication No. 7-197938). In this the rolling bearing apparatus for vehicles, a rolling member is interposed between respective raceway surfaces of an inner ring constituting a rotating ring and an outer ring constituting a fixed ring. A space between the inner and outer rings is sealed by a seal device.

The rotation detector comprises an encoder element fixed to the inner ring and a detection element fixed to the outer ring. The detection element detects the rotational state of the inner ring by detecting the encoder element.

An example of application of the bearing apparatus provided with the rotation detector to an automobile is one wherein a bearing apparatus for rotatably supporting an axle of an automobile with respect to a vehicle body is provided with a rotation detector used for ABS or the like. More specifically, it is constituted such that the inner ring of the bearing apparatus is outward fitted on the axle of the automobile. The outer ring is fixed to the vehicle body via a knuckle and the sensor detects changes in the magnetic field of a pulser ring fixed on the inner ring. The detection signal is transmitted to an electronic circuit of the vehicle body via a wire harness.

Normally, the sensor is fixed to the knuckle and the electronic circuit is provided at the vehicle body. For this reason, since the knuckle is connected to a damper against swaying of the vehicle body when running, vibration of the vehicle body is not transmitted to the knuckle. Therefore, the electronic circuit provided at the vehicle body is therefore caused to vibrate by swaying of the vehicle body. The sensor, however, is fixed to the knuckle is not influenced by vibration of the vehicle body. Thus the wire harness connecting the sensor and the electronic circuit may become disconnected because of the vibration of the vehicle body. Further, recently, to save space, ABS sensors have been incorporated in a seal device, known as a pack seal, which is fitted on the bearing apparatus. For this reason there are the following problems: if the wire harness disconnects and the ABS sensor is in an abnormal state, it is necessary to replace the entire hub unit that includes the bearing apparatus. Accordingly the maintenance operation takes time and labor, and the expense is high. Moreover, the weight of the wire harness is applied to the connecting portion between the sensor and the wire harness due to vehicle body swaying or the like. Accordingly, disconnection may occur due to inadequate strength at the connecting portion.

### BRIEF SUMMARY OF THE INVENTION

The present invention is a sensor assembly which is fixed to an outer ring member of a rolling bearing apparatus for vehicles and which detects the rotational state of an inner ring member. It comprises a seal ring, a sensor integrally provided at the seal ring, an external member which molds the sensor with resin to integrate the sensor with the seal ring, a sensor side connector whose one end is successively formed with the external member and whose other end is freely attachable/detachable with a wire harness side connector, and a reinforcing member which is coupled to at least either of the external member or the sensor side connector and which reinforces the strength of the sensor side connector.

Preferably, the other end of the external member extends radially outward, and the reinforcing member is constituted by an extension portion of the seal ring which extends towards the other end of the external member.

Preferably, the other end of the sensor side connector extends radially outward, and the reinforcing member is constituted by the extension portion of the seal ring which extends towards the other end of the sensor side connector.

A seal device of the present invention comprises an outer ring side seal ring which is fixed to an outer ring member and composed of nonmagnetic material, an inner ring side seal ring fixed to an inner ring member, a magnetic sensor provided at the periphery of the outer ring side seal ring, a magnetic body ring which constitutes a rotation detector in conjunction with the magnetic sensor and is integrally provided at a position radially opposite the magnetic sensor in the inner ring side seal ring, an external member which molds the magnetic sensor with resin to integrate the magnetic sensor with the outer ring side seal ring, a sensor side connector whose one end is successively formed with the external member and whose other end is constituted to be freely attachable/detachable from a wire harness side connector, and a reinforcing member which is coupled to at least either of the external member or the sensor side connector and reinforces the strength of the sensor side connector.

The rotation detector used, for example, is an active type detector which changes output according to changes in magnetic flux. The magnetic body ring includes the pulser ring, and the magnetic sensor includes a magnetic sensor which is comprised of two magnetic detection portions disposed circumferentially apart from each other.

A vehicle rolling bearing apparatus of the present invention comprises an outer ring member fixed to a vehicle body side, an inner ring member which is concentrically disposed with the outer ring member, a plurality of rolling members which are rotatably disposed between the outer ring member and the inner ring member, an outer ring side seal ring fixed to the outer ring member, an inner ring side seal ring which constitutes a seal device in conjunction with the outer ring side seal ring and is fixed to the inner ring member, a magnetic sensor integrally provided at the outer ring side seal ring, an external member which molds the magnetic sensor with resin to integrate the magnetic sensor with the outer ring side seal ring, a sensor side connector whose one end is successively formed with the external member and whose other end is attachable/detachable with a wire harness side connector, a reinforcing member which is coupled to at least either of the external member or the sensor side connector and reinforces the strength of the sensor side connector, and a pulser ring which constitutes a rotation detector in conjunction with the magnetic sensor and which is fixed to a side of the inner ring side seal ring.

According to the rolling bearing apparatus of the present invention, the rotation detector comprising the magnetic sensor and the magnetic body ring is integrated with the seal device and the sensor side connector connected to the magnetic sensor is successively formed with the external member which molds the magnetic sensor with resin, so the seal device, the rotation detector, and the sensor side connector are integrated.

The wire harness for connecting the magnetic sensor and the electronic circuit of the vehicle body is connected to the electronic circuit at one end, and at the other end has the wire harness side connector which is attachably/detachably connected to the sensor side connector which is integrally molded with the magnetic sensor. The electronic circuit is connected to the magnetic sensor by attachably/detachably connecting the wire harness side connector to the sensor side connector which is integrally provided at the magnetic sensor. Thus, the wire harness is separated from the integrated object comprising the seal device, the rotation detector, and the sensor side connector, so that if the wire harness breaks due to swaying of the vehicle body when running, replacement is easily performed by removing just the wire harness from the sensor side connector portion, thereby making it possible to easily perform maintenance inexpensively.

In the sensor assembly constituting the outer ring side seal ring of the seal device, the seal ring extends in an outer diameter direction to form a reinforcement portion, and the sensor side connector integrally provided at the external member is reinforced with the reinforcement portion. Hence, when the wire harness side connector is connected to the sensor side connector and the weight of the wire harness is applied to the sensor side connector formed at the weak in strength external member, the sensor side connector can be prevented from bending in the direction of the reinforcement portion, thereby preventing magnetic sensor line breaks or the like.

According to the rolling bearing apparatus of the present invention, the rotation detector comprising the magnetic sensor and the magnetic body ring is integrally molded with the seal device, and the sensor side connector connected to the magnetic sensor is successively formed with the external member which molds the magnetic sensor with resin, so that the seal device, the rotation detector, and the sensor side connector are integrated.

The wire harness for connecting the magnetic sensor and the electronic circuit of the vehicle body is connected to the electronic circuit at one end, and at the other end has the sensor side connector which is attachably/detachably connected to the wire harness side connector which is integrated with the magnetic sensor. The magnetic sensor and the electronic circuit are connected by attachably/detachably connecting the wire harness side connector to the sensor side connector. Thus, the wire harness is separated from the integrated object comprising the seal device, the rotation detector, and the sensor side connector, so that when the wire harness breaks due to swaying of the vehicle body when running, replacement is easily performed by removing just the wire harness from the sensor side connector portion, thereby making it possible to easily perform maintenance inexpensively.

In the sensor assembly constituting the outer ring side seal ring of the seal device, a contact surface which makes contact with an outer peripheral surface of the outer ring member is formed at the sensor side connector integrally provided at the external member which extends in the outer diameter direction. Hence, when the wire harness side connector is connected to the sensor side connector and the weight of the wire harness is applied to the sensor side connector formed at the weak in strength external member, the connector can be prevented from bending in the direction of the outer peripheral surface of the outer ring member, thereby preventing magnetic sensor line breaks or the like.

### BRIEF DESCRIPTION OF THE DRAWINGS

Accompanying the specification are figures which assist in illustrating the embodiments of the invention, in which:

FIG. 1 is a cross sectional view showing the entire constitution of a rolling bearing apparatus for vehicles according to an embodiment of the present invention;

FIG. 2 is an expanded sectional view of a principal portion of FIG. 1;

FIG. 3 (A) is a signal waveform diagram of one detection portion of the two magnetic detection portions constituting a magnetic sensor;

FIG. 3 (B) is a signal waveform diagram of the other detection portion of the two magnetic detection portions constituting the magnetic sensor;

FIG. 4 is an explanatory diagram of the magnetic sensor;

FIG. 5 (A) is an oblique view from the front of the seal device;

FIG. 5 (B) is an oblique view from the back of the same seal device;

FIG. 6 is a cross sectional view of the seal device 30, omitting a sensor side connector;

FIG. 7 is a cross sectional view of the seal device including the sensor side connector;

FIG. 8 is a cross sectional view showing a portion of a rolling bearing apparatus for vehicles according to another embodiment of the present invention;

FIG. 9 is an enlarged view of a principal portion of FIG. 8;

FIG. 10 (A) is an oblique view from the front of the seal device of FIG. 8;

FIG. 10 (B) is an oblique view from the back of the seal device of FIG. 8; and

FIG. 11 is a cross sectional view showing a portion of a rolling bearing apparatus for vehicles according to still another embodiment of the present invention.

### DETAILED DESCRIPTION OF THE INVENTION

Referring to the drawings, description will be made in detail of a rolling bearing apparatus for vehicles according to a preferred embodiment of the present invention.

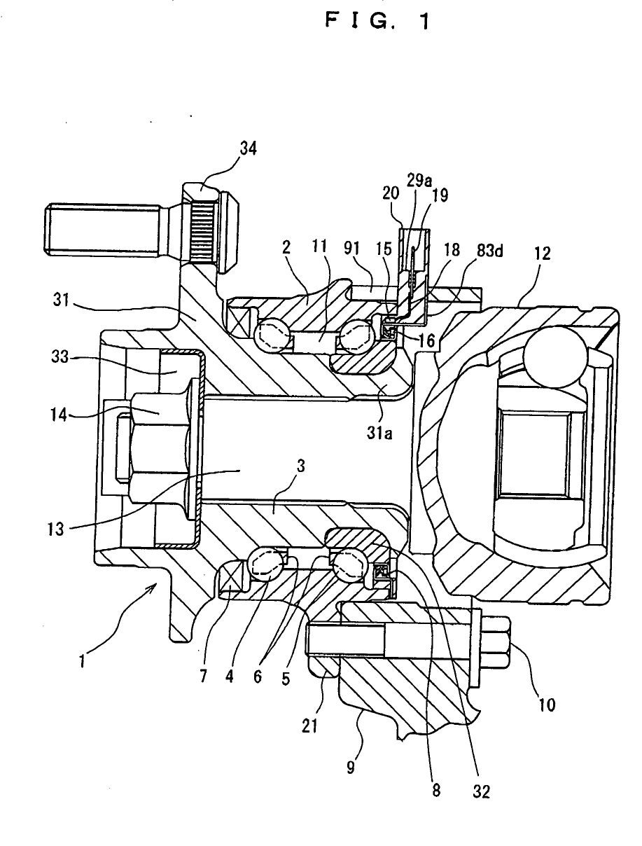

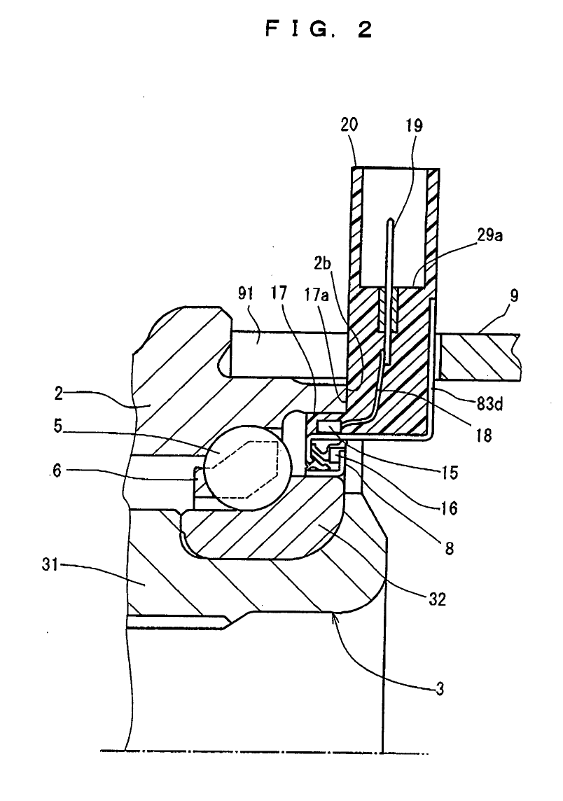

FIG. 1 is a cross sectional view showing the entire constitution of the rolling bearing apparatus for vehicles according to the embodiment of the present invention, and FIG. 2 is an expanded sectional view of a principal portion of FIG. 1. In these drawings, the left side is a vehicle outward side and the right side is a vehicle inward side. Although the rolling bearing apparatus 1 is for driving wheels, it can also be applied to a coupled driving wheel.

A flange portion 21 formed on an outer peripheral surface of an outer ring member 2 as a fixing ring is fixed to a knuckle 9 via a bolt 10, and the outer ring member 2 is thereby unrotatably supported by the vehicle body. Two outer ring raceway surfaces are formed on an inner peripheral surface of the outer ring member 2 in an axial direction. An inner ring member 3 is a rotating ring constituted by a hub wheel 31 and an inner ring 32. The hub wheel 31 and the inner ring 32 are rotatably supported by the outer ring member 2 via rolling members 4 and 5 which are constituted by balls in respective rows circumferentially disposed at equidistant positions in a snap cage 6, respectively.

A flange portion 34 is integrally formed radially outward on an outer peripheral surface of the hub wheel 31 at the vehicle outward side. A brake disc rotor and a tire wheel are mounted on the flange portion 34 and a wheel is mounted on the tire wheel.

An outer peripheral surface more to the vehicle inward side than from the flange portion 34 of the hub wheel 31 is used as the inner ring raceway surface of the rolling member 4 of one row. A cylindrical minor diameter portion 31a is formed on the hub wheel 31 at the vehicle outward side, and the inner ring 32 is outward fitted to an outer peripheral surface of this minor diameter portion 31a. An outer peripheral surface of the inner ring 32 is used for an inner ring raceway surface of the rolling member 5 of the other row. At the edge face on the vehicle inward side of the inner ring 32, an edge section deformed outward in the minor diameter portion 31a of the hub wheel 31 direction is crimped.

A shaft portion 13 is integrally formed with a bowl shaped outer ring member 12 of a constant velocity joint. The shaft portion 13 is inserted into a central hole of the hub wheel 31 via a spline. A nut 14 is screwed to an end section of the shaft portion 13 at the vehicle outward side and is tightened to an end face of a recess portion 33 of the hub wheel 31. Thus the necessary pre pressure is applied to the rolling members 4 and 5 of both rows, and the bowl shaped outer ring member 12 is incorporated with the hub wheel 31 and rotates integrally therewith.

Seal devices 7 and 8 hermitically seal a ring shaped bearing space 11 between the outer ring member 2 and the inner ring member 3 from both sides in the axial direction at the vehicle outward side and the vehicle inward side, respectively. Thereby, the seal devices 7 and 8 prevent lubricant inside the ring shaped bearing space 11 from leaking out and prevent mud, water or the like from infiltrating. The seal device 7, for example, is constituted by adhering a rubber lip (not shown) which slidingly contacts the hub wheel 31 to a ring shaped core metal (not shown) which is inwardly fitted to the outer ring member 2.

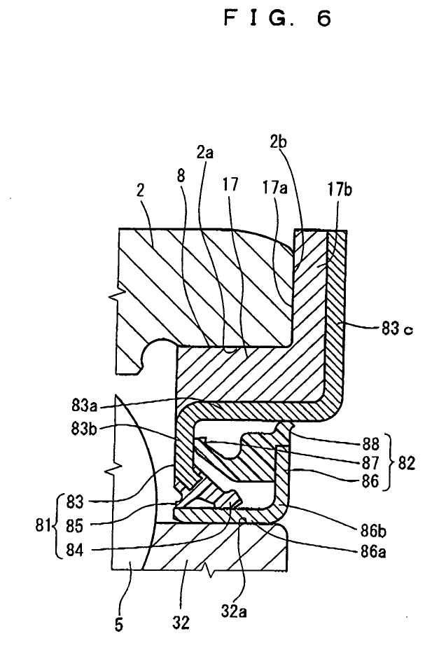

The seal device 8 is constituted by combining an outer ring side seal ring 81 (FIG. 6), which is one of the components of the sensor assembly, and an inner ring side seal ring 82. The sensor assembly comprises the outer ring side seal ring 81, a magnetic sensor 15, and an external member 17.

The outer ring side seal ring 81 is attached to the side of the outer ring member 2 and comprises a ring shaped core metal 83, and a main lip 84 and an auxiliary lip 85 to cover this ring shaped core metal 83. The ring shaped core metal 83 comprises a cylindrical portion 83a extended in the axial direction, and a ring shaped plate portion 83b extended radially inward from an inner edge side in the axial direction of the cylindrical portion 83a. The ring shaped core metal 83 is a nonmagnetic ring, and is made of a nonmagnetic material, for example nonmagnetic stainless steel or the like.

The inner ring side seal ring 82 is attached to the side of the inner ring 32 and consists of a ring shaped core metal 86, and an axial direction lip 87 and a radial direction lip 88 to cover this ring shaped core metal 86. The ring shaped core metal 86 comprises a cylindrical portion 86a which extends in the axial direction and radially opposes the cylindrical portion 83a, and a ring shaped plate portion 86b which extends radially outward from an outer edge side in the axial direction of the cylindrical portion 86a and axially opposes the ring shaped plate portion 83b. The respective lips 84, 85, 87, and 88 are made of rubber such as nitrile butadiene rubber (NBR) or the like, and are vulcanized to adhere to the ring shaped core metal 83 and 86.

The magnetic sensor 15 for detecting the rotational state of the inner ring member is integrally incorporated in the outer ring side seal ring 81 and the pulser ring 16 that is a magnetic ring is integrally incorporated in the inner ring side seal ring 82. The rotation detector for detecting the rotation of the inner ring 32 comprises the magnetic sensor 15 and the pulser ring 16.

The magnetic sensor 15 is mounted in a non contact manner above the outer peripheral surface of the cylindrical portion 83a in the ring shaped core metal 83 of the outer ring side seal ring 81. It is provided by integrally molding (insert molding) the external member 17 which resin molds the magnetic sensor 15 at the outer diameter of the cylindrical portion 83a. The external member 17 is made of an engineering plastic, preferably poly phenylene sulphide (PPS), poly butylene terephthalate (PST), poly amide (PA) or the like.

A sensor side connector 20 is integrally molded with the external member 17. One end of the sensor side connector 20 extends to the external member 17 and the other end extends in the outer diameter direction and is attachably/detachably connected to a wire harness side connector (not shown) connected to the electronic circuit of the vehicle body. The sensor side connector 20 is preferably made of an engineering plastic, such as PPS, PBT, PA, or the like. A pin 19 for connection with the wire harness side connector projects from the bottom face of a recess portion 29a on the other end side inside the sensor side connector 20, and the magnetic sensor 15 and the pin 19 are connected to a signal line 18.

A ring shaped outer ring member contact surface 17a which makes contact with the end face 2b in the axial direction of the outer ring member 2 is formed on the external member 17. A catch for locking with the wire harness side connector may be provided at the periphery of the sensor side connector 20.

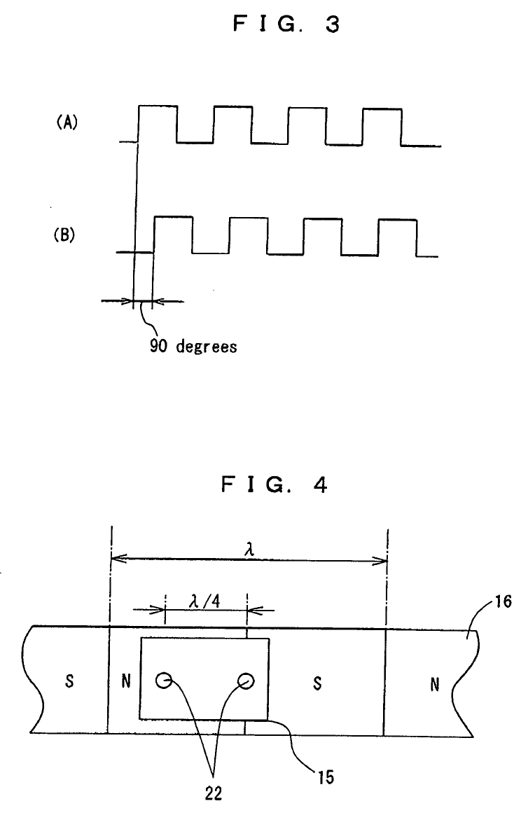

The magnetic sensor 15 comprises two magnetic detection portions which are disposed circumferentially apart from each other, such as a Hall element or a magnetoresistive element, and is capable of detecting rotational direction in addition to rotational angle. With regard to a rotational phase relationship between detection signals of two magnetic sensor portions, the magnetic sensors are disposed such that when one magnetic sensor produces a first rectangular wave signal as shown in FIG. 3 (A), the other magnetic sensor produces a second rectangular wave signal, the phase of which is shifted from that of the first rectangular signal by 90 degrees as shown in FIG. 3 (B). Whether the rotational direction of the inner ring 3 is right or left can be determined according to a phase advance or a phase delay between both detection signals that the respective magnetic detection portions produce.

As shown in FIG. 4, a Hall IC incorporating two Hall elements 22 is preferably used as the magnetic detection portion of the magnetic sensor 15. That is, it is constituted such that two Hall elements 22 are disposed at an interval (λ/4) so that the phase difference between outputs from the respective Hall elements is 90 degrees relative to the magnetizing pitch λ of the pulser ring 16, thereby making it possible to detect the rotational direction. The magnetizing pitch λ is the total length of N pole and S pole magnetization.

The pulser ring 16 is formed by vulcanizing and molding rubber that contains a magnetic powder, and is magnetized with a configuration such that N pole and S pole pieces are disposed alternately in the circumferential direction, for example. The pulser ring 16 is fixed to an inner surface of the ring shaped plate portion 86b in the ring shaped core metal 86 of the inner ring side seal ring 82. The magnetic sensor 15 is fixed to a position where it is capable of detecting a change in the magnetic field of the pulser ring 16. The sensing direction (inner diameter direction) of the magnetic sensor 15 and the magnetization direction (axial direction) of the pulser ring 16 are orthogonal to each other.

In the seal device 8, with regard to the outer ring side seal ring 81 into which the magnetic sensor 15 is incorporated, the external member 17 is press fitted to a shoulder portion 2a of the inner peripheral surface of the outer ring member 2. With regard to the inner ring side seal ring 82 in which the pulser ring 16 is incorporated, the ring shaped core metal 86 is press fitted to a shoulder portion 32a of the outer peripheral surface of the inner ring 32. The seal device 8 is thereby attached tightly to the outer ring member 2 and the inner ring 32. The seal device 8 is positioned by causing an outer ring contact surface 17a to make contact with the end face 2b in the axial direction of the outer ring member 2.

In the rolling bearing apparatus 1 provided above, the edge section of the outer ring member 2 on the vehicle inward side is inwardly fitted to the knuckle 9, and the flange portion 21 of the outer ring member 2 is fixed to the knuckle 9 with the bolt 10. The knuckle 9 is formed as a cylinder, and a cutout 91 into which the sensor side connector 20 is inserted is formed at the vehicle outward side. The rolling bearing apparatus 1 is fixed to the knuckle 9 in a state in which the sensor side connector 20 has been inserted into the cutout 91.

The wire harness side connector is provided at the tip of the wire harness connected to the electronic circuit of the vehicle body. The sensor side connector 20 is attachable/detachable with this wire harness side connector. Since the wire harness side connector is connected to the sensor side connector 20, the magnetic sensor 15 is connected to the electronic circuit of the vehicle body via a connection with the sensor side connector 20 and the wire harness side connector.

In the rolling bearing apparatus 1, when the inner ring member 3 rotates in a state in which the outer ring member 2 is unrotatably fixed to the knuckle 9, each pole piece of the pulser ring 16, which integrally rotates with the inner ring member 3, successively opposes each of the magnetic detection portions of the magnetic sensor 15. When this happens, the position of the pulser ring 16 opposite each of the magnetic detection portions of the magnetic sensor 15 successively changes, so the direction of magnetic flux generated from the pulser ring 16 alternately changes, and first and second rectangular wave signals are output from the magnetic sensor 15. The waveform period of each of these rectangular wave signals changes according to the rotational phase and rotational speed of the pulser ring 16. Processing the waveform of each rectangular wave signal finds the rotational phase, the rotational speed, the rotational frequency, the rotational direction and the like of the inner ring member 3.

In the rolling bearing apparatus 1 the wire harness is separated from the integrated object comprising the seal device 8, the magnetic sensor 15, the pulser ring 16, and the sensor side connector 20. Because of this separation, when the wire harness is broken by swaying of the vehicle body when running, the wire harness side connector can be removed with ease from the sensor side connector to replace the wire harness. Accordingly, it is possible to easily perform maintenance inexpensively.

Since the wire harness is separated from the integrated object comprising the seal device 8, the magnetic sensor 15, the pulser ring 16, and the sensor side connector 20, when the rolling bearing apparatus 1 is fixed to the knuckle 9 in a state in which the integrated object is fitted onto the rolling bearing apparatus 1, there is no wire harness to interfere with the fixing operation. Accordingly, there is an improving mountability in vehicles.

The pulser ring 16 is provided at the ring shaped core metal 86 of the inner ring side seal ring 82, and the magnetic sensor 15 is provided at the ring shaped core metal 83 of the outer ring side seal ring 81, and the pulser ring 16 and the magnetic sensor 15 are integrated with the seal device 8. Due to this integrated constitution, compact formation of the rotation detector can be achieved and it can be easily installed even in a small space such as the driving wheel side.

The pulser ring 16 is fixed to the ring shaped core metal 86 of the inner ring side seal ring 82, and the magnetic sensor 15 is molded with resin by the external member 17 to be integrated with the ring shaped core metal 83 of the outer ring side seal ring 81. Accordingly, hermetically sealing performance of the pulser ring 16 and the magnetic sensor 15 is improved. This improves the dust resistance performance of the rolling bearing apparatus.

Since the signal line 18 of the magnetic sensor 15 is molded with resin by the external member 17, a connecting portion between the magnetic sensor 15 and the signal line 18 is reinforced. Accordingly, breaks are prevented in the signal line 18. Furthermore, since the wire harness is separated from the integrated object comprising the seal device 8, the magnetic sensor 15, the pulser ring 16, and the sensor side connector 20, the weight of the wire harness is not applied to the external member 17. This prevents deterioration in the hermetically sealing performance of the external member 17 due to lack of strength while the wire harness is attached to the connector 20.

The sensor side connector 20 is integrally formed at the external member 17 which resin molds the magnetic sensor 15 of the outer ring side seal ring 81. This results in excellent insulation and vibration resistance performance and reduced costs. The sensor side connector 20 is provided inserted into the cutout 91 formed on the knuckle 9 on the vehicle outward side. Accordingly, it is not necessary to form a through hole in the middle of the axial direction of the knuckle 9 as in prior art. This helps prevent deterioration of the strength of the knuckle 9.

As disclosed, the sensor side connector 20 projecting in the outer diameter direction engages with the cutout 91 from the vehicle outward side in a state in which the rolling bearing apparatus 1 is fitted with the seal device 8 with which the sensor side connector 20 is integrally formed. As a result, the rolling bearing apparatus 1 can be fixed to the knuckle 9 with ease. Since the magnetic sensor 15 is molded by the external member 17 and is integrally formed with the outer ring side seal ring 81, the magnetic sensor 15 is protected from an external environment. Accordingly, there is an improving reliability.

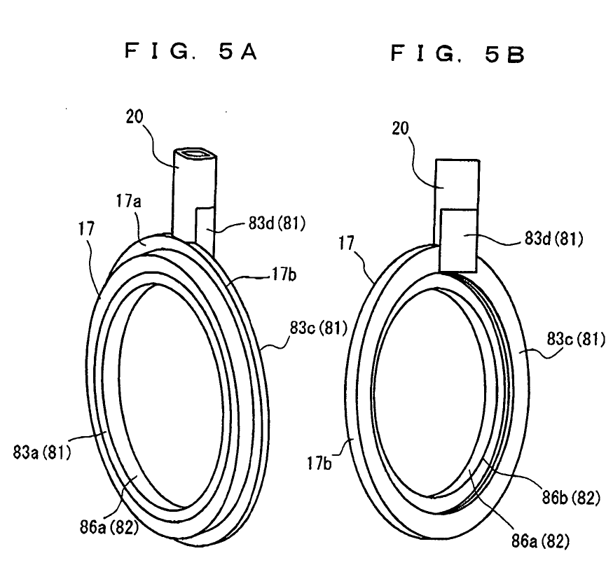

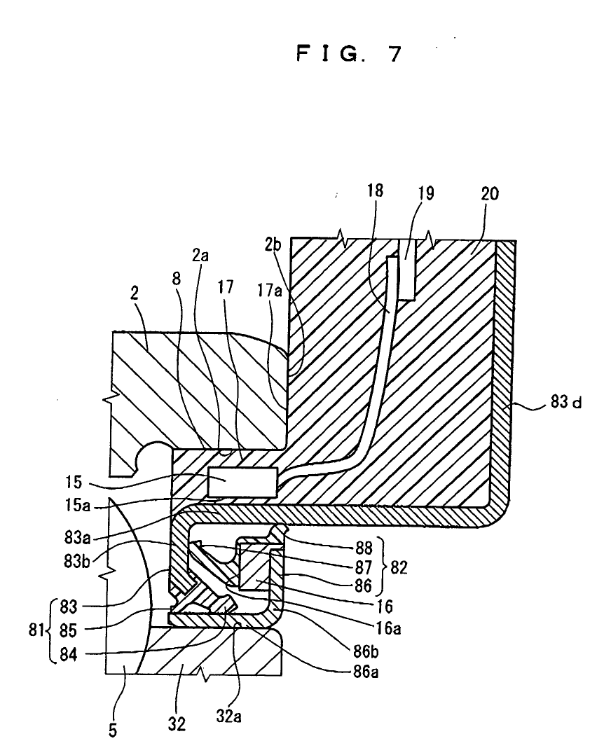

Referring to FIG. 5 through FIG. 7, description will further be made of the seal device 8, especially of the outer ring side seal ring 81 and the external member 17. FIG. 5 (A) is an oblique view from the front of the seal device 8, FIG. 5 (B) is an oblique view from the back of the same seal device 8, FIG. 6 is a cross sectional view of the seal device 8 without the sensor side connector 20, and FIG. 7 is a cross sectional view of the seal device 8 including the sensor side connector 20.

The outer ring side seal ring 81 comprises the ring shaped core metal 83, and the main lip 84 and the auxiliary lip 85 which fitted on this ring shaped core metal 83 as described above. The ring shaped core metal 83 comprises a cylindrical portion 83a and a ring shaped plate portion 83b.

The inner ring side seal ring 82 comprises the ring shaped core metal 86, and the axial direction lip 87 and the radial direction lip 88 which cover this ring shaped core metal 86. The ring shaped core metal 86 of the inner ring side seal ring 82 comprises a cylindrical portion 86a and a ring shaped plate portion 86b.

The other end of the external member 17 is formed into a ring shape, extending radially outward. One end of the sensor side connector 20 is integrally formed at the other end of the external member 17. Its other end is formed into a cylindrical shape, extending radially outward further than the other end of the external member 17.

The cylindrical portion 83a of the ring shaped core metal 83 of the outer ring side seal ring 81 extends towards the vehicle inward side and is bent radially outward at two intermediate points along such extension. That is, for an extension end section of the cylindrical portion 83a on the vehicle inward side, as shown in FIG. 6 and FIG. 7, one of the bent portions thereof is formed as a ring shaped reinforcement portion 83c facing the back face of the other end of the external member 17. On the other hand, the other bent portion thereof is formed as a half cylindrical reinforcement portion 83d facing the other end of the sensor side connector 20. It is not mandatory to have both reinforcement portions 83c and 83d. That is, having only reinforcement portion 83d is sufficient.

The reinforcement portion 83c covers the whole back face of a ring shaped portion 17b of the external member 17 having the outer ring contact surface 17a. The reinforcement portion 83d covers the surface of the sensor side connector 20 from its one end to the other end. Thus the reinforcement portion 83d covers the vehicle inward side surface of the sensor side connector 20 and is formed in a successive formation with the reinforcement portion 83c. The length of the reinforcement portion 83d in the radial direction reaches an intermediate point of the connector 20 in the radial direction, and may also be formed over the whole length of the connector 20 in the radial direction. The shape of the reinforcement portion 83d is not limited to one covering the vehicle inward side surface of the connector 20. The shape may also be formed to cover the entire perimeter of the connector 20, for example.

In the sensor assembly constituting the outer ring side seal ring 81 of the seal device 8, the reinforcement portions 83c and 83d are formed by extending the ring shaped core metal 83 on the vehicle inward side in the outer diameter direction. The sensor side connector 20 formed successively with the external member 17 is reinforced by the reinforcement portions 83c and 83d.

Therefore, when the sensor side connector 20 is attachably/detachably connected to the wire harness side connector and the weight of the wire harness is applied to the sensor side connector 20 formed at the thin, weak in strength external member 17, the sensor side connector 20 is prevented from being bent in the direction of the reinforcement portions 83c and 83d, i.e. toward the vehicle inward side (knuckle side). Accordingly, disconnection is prevented of the signal line 18 of the magnetic sensor 15 and deterioration is prevented of hermetically sealing performance of the external member 17 or the like. Thus, there is an improved reliability.

Furthermore, since the signal line 18 of the magnetic sensor 15 is resin molded by the external member 17, the connecting portion between the magnetic sensor 15 and the signal line 18 is reinforced. Accordingly, disconnection is further prevented.

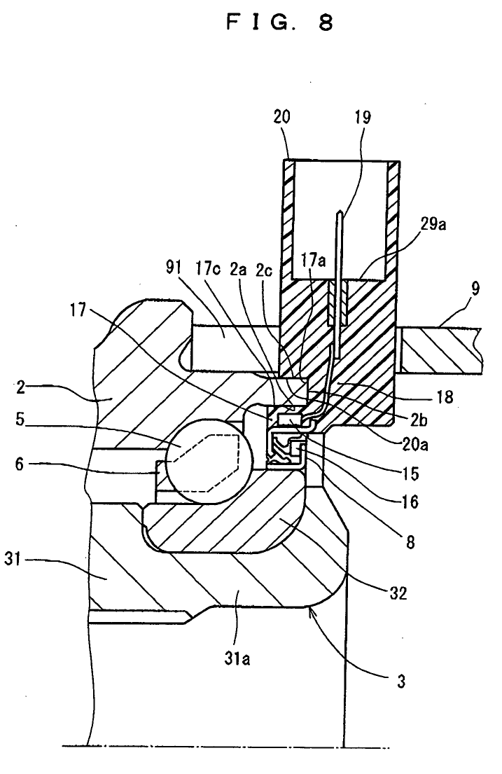

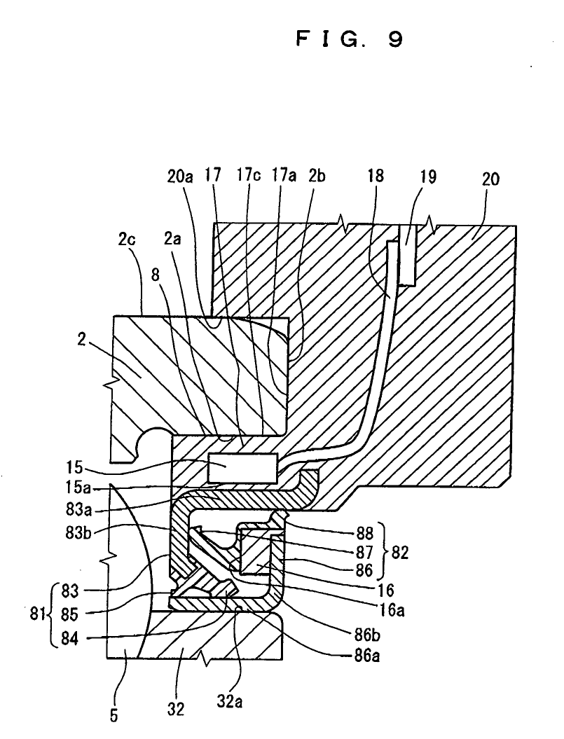

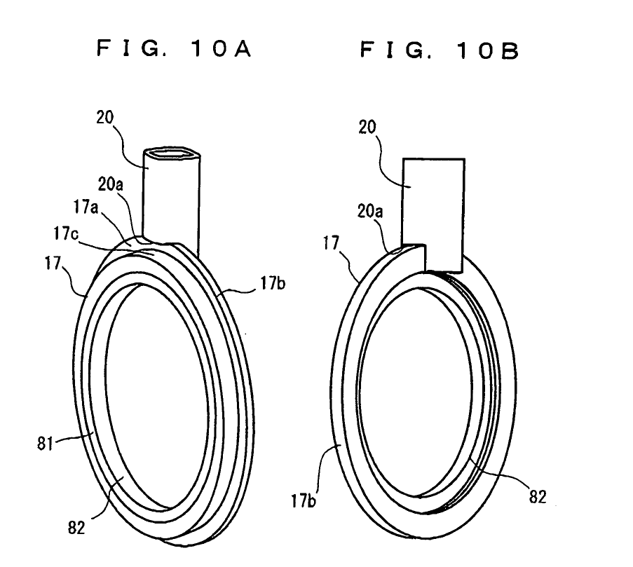

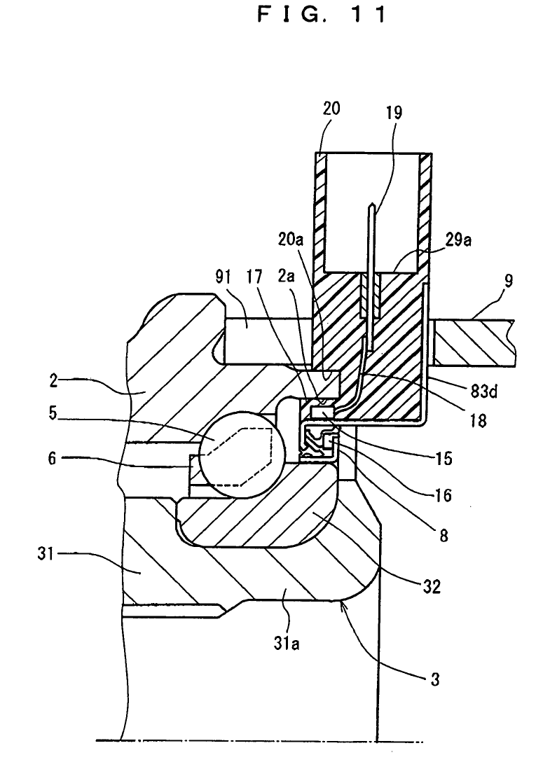

Referring to FIGS. 8 through 10, explanation will be made of another embodiment of the present invention. In these drawings, the same symbol is given to a component that is the same as or corresponds to a component of FIGS. 1 through 7 and detailed description of the that component will be omitted.

The ring shaped positioning face 17a, which makes contact with the end face 2b in the axial direction of the outer ring member 2, is formed at the external member 17. In addition, a contact surface 20a, which makes contact with an outer peripheral surface 2c of the outer ring member 2, is formed on the sensor side connector 20 at the vehicle outward side.

The seal device 8 is positioned so that the positioning face 17a of the external member 17 makes contact with the end face 2b in the axial direction of the outer ring member 2. In this state, it is disposed such that the contact surface 20a of the sensor side connector 20 makes contact with the outer peripheral surface 2c of the outer ring member 2 and the sensor side connector 20 overlaps the outer ring member 2. In other words, an edge section of the outer ring member 2 on the vehicle inward side is inserted into a recess portion formed between the contact surface 20a of the sensor side connector 20 and the outer peripheral surface 17c of the external member 17.

The outer peripheral surface 2c of the outer ring member 2 which makes contact with the contact surface 20a of the sensor side connector 20 is not limited to a cylindrical surface. For example, by forming a recess portion only at the portion which the contact surface 20a of the sensor side connector 20 contacts and by fitting the sensor side connector 20 into this recess portion, it may be used as a guide for circumferential position when the seal device 8 is fixed to the outer ring member 2.

According to the above constitution, in the sensor assembly constituting the outer ring side seal ring 81 of the seal device 8, the contact surface 20a which makes contact with the outer peripheral surface 2c of the outer ring member 2 is formed at the sensor side connector 20 which extends in the outer diameter direction and is successively formed with the resin made external member 17.

Hence, when the wire harness is connected to the sensor side connector 20 and the weight of the wire harness is applied to the sensor side connector 20 formed at the resin made weak in strength external member 17, since the outer ring member 2 becomes the reinforcing member for the sensor side connector 20, the sensor side connector 20 from is prevented being bent in the direction of the outer peripheral surface of the outer ring member, i.e. to the vehicle outward side (tire side). Thus, disconnection is prevented of the signal line 18 of the magnetic sensor 15 and deterioration is prevented of hermetically sealing performance of the resin made external member 17 or the like. Accordingly, reliability is improved.

Furthermore, since the signal line 18 of the magnetic sensor 15 is molded by the resin made external member 17, the connecting portion between the magnetic sensor 15 and the signal line 18 is reinforced. Thus, disconnection is further prevented.

Description will be made of still another embodiment of the present invention based on FIG. 11. Referring to FIG. 11, the contact surface 20a, which makes contact with the outer peripheral surface 2c of the outer ring member 2, is formed on the sensor side connector 20 at the vehicle outward side in this additional embodiment of the present invention. In this embodiment, since the contact surface 20a which makes contact with the outer peripheral surface 2c of the outer ring member 2 is additionally formed at the sensor side connector 20, it is possible to prevent the sensor side connector 20 from being bent almost to the vehicle outward side. The sensor side connector 20 is therefore held essentially at the vehicle outward side or essentially at the vehicle inward side. Accordingly, it is possible to prevent disconnection of the signal line 18 or the like. Thus, reliability is improved.

It is sufficient if the reinforcement portion is formed only for at least a portion of the sensor side connector 20. The magnetic sensor 15 may be a sensor for only detecting rotational speed of the axle of the automobile. A constitution for the seal device 8 is sufficient provided there is with the outer ring side seal ring 81 constituting the sensor assembly. No particular limitations are placed with respect to the disposition and form of the magnetic sensor or the magnetic ring.

The present invention can be applied to a rolling bearing apparatus for rotatably supporting an axle of a vehicle such as an automobile or the like on a vehicle body.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1.-30. (canceled)

31. A sensor assembly connecting to an outer ring member of a rolling bearing apparatus, said sensor assembly detecting a rotational state of an inner ring member, said sensor assembly comprising:
a seal ring;
a sensor disposed against said seal ring;
an external member resin-molding said sensor to said seal ring;
a sensor connector including first and second ends, said first end disposed against said external member and said second end being connectable to a wire harness connector; and
a reinforcing member connecting to either said external member or said sensor connector, said reinforcing member reinforcing said sensor connector.

32. The sensor assembly of claim 31, wherein:
said external member has first and second ends;
said second end of said external member extends radially outward; and
said reinforcing member defining an extension portion of said seal ring, said extension portion extending towards said second end of said external member.

33. The sensor assembly of claim 32, wherein:
said external member has a back face and said reinforcing member being disposed against said back face of said external member.

34. The sensor assembly of claim 31, wherein:
said second end of said external member extends radially outward; and
said reinforcing member defining an extension portion of said seal ring, said extension portion extending towards said second end of said sensor connector.

35. The sensor assembly of claim 34, wherein said reinforcing member covers a portion of said sensor connector.

36. The sensor assembly of claim 31, wherein:
said extension member has first and second ends, said second end including a back face;
said second end of said extension member being ring shaped and extending radially outward;
said first end of said sensor connector connecting to said second end of said external member, and said second end of said sensor connector being cylindrically shaped and extending radially outward beyond said second end of said external member;
said seal ring including an outer ring;
said reinforcing member including a ring-shaped member, said ring-shaped member defining a first extension portion of said outer ring, said first extension portion extending along said back face of said second end of said external member; and
said reinforcing member including a semi-cylindrical member, said semi-cylindrical member defining a second extension portion of said outer ring, said second extension portion extending along said second end of said sensor connector.

37. The sensor assembly of claim 31, wherein:
said seal ring includes an outer ring member, said outer ring member including an outer peripheral surface; and
said sensor connector includes a contact surface for contacting said outer peripheral surface of said outer ring member.

38. The sensor assembly of claim 31, wherein:
said external member and said sensor connector are integrally molded;
a signal line and a pin each being disposed within said integral external member and sensor connector;
said signal line and pin each having first and second ends, said first end of said line connecting to said sensor, and said first end of said pin connecting with said second end of said signal line; and
said second end of said sensor connector including a recess portion, said recess portion including a bottom face, said second end of said pin protruding through said bottom face of said recess portion;
the wire harness connector being connectable to said second end of said pin through said recess portion.

39. The sensor assembly of claim 31, wherein:
said sensor is a magnetic sensor;
said seal ring including an outer ring, said outer ring including an outer periphery side, said outer ring being a nonmagnetic material; and
said magnetic sensor being disposed on said outer periphery side of said outer ring.

40. The sensor assembly of claim 39, wherein:
said magnetic sensor includes two magnetic detection portions disposed circumferentially apart from each other; and
signals output from both said magnetic detection portions are phase differentiated by 90 degrees.

41. A seal apparatus, comprising:
a seal ring including an outer ring, said outer ring being nonmagnetic and including an outer periphery side;
an outer member connecting to said outer ring of said seal;
said seal ring including an inner ring;
an inner ring member connecting to said inner ring of said seal;
a magnetic sensor being disposed at said outer periphery side of said outer ring;
a magnetic ring, said magnetic ring and said magnetic sensor defining a rotation detector, said magnetic ring connecting to said inner ring, said magnetic ring radially opposing said magnetic sensor;
an external member resin-molding said magnetic sensor to said outer ring side seal ring;
a sensor connector including first and second ends, said first end being connected to said external member and said second end being connectable to a wire harness connector; and
a reinforcing member connecting to either of said external member or said sensor connector, said reinforcing member reinforcing said sensor side connector.

42. The seal apparatus of claim 41, wherein:
said external member has first and second ends;
said second end of said external member extends radially outward; and
said reinforcing member defining an extension portion of said seal ring, said extension portion extending towards said second end of said external member.

43. The seal apparatus of claim 42, wherein said external member has a back face, and said reinforcing member being disposed against said back face of said external member.

44. The seal apparatus of claim 41, wherein:
said second end of said external member extends radially outward; and
said reinforcing member defining an extension portion of said outer ring, said extension portion extending towards said second end of said sensor connector.

45. The seal apparatus of claim 44, wherein said reinforcing member covers at least a portion of said sensor connector.

46. The seal apparatus of clam 41, wherein:
said external member includes first and second ends, said second end of said external member being ring shaped and extending radially outward;
said first end of said sensor connector being connected to said second end of said external member;
said second end of said sensor connector being cylindrically shaped and extending radially outward beyond said second end of said external member;
said second end of said external member including a back face;
said reinforcing member including a ring-shaped member, said ring-shaped member defining a first extension portion of said outer ring, said first extension portion extending along said back face of said second end of said external member; and
said reinforcing member including a semi-cylindrical member, said semi-cylindrical member defining a second extension portion of said outer ring, said second extension extending towards said second end of said sensor connector.

47. The seal apparatus of claim 41, wherein:
said seal ring includes an outer ring member, said outer ring member including an outer peripheral surface; and
said sensor connector including a contact surface for contacting said outer peripheral surface of said outer ring member.

48. The seal apparatus of claim 41, wherein:
said magnetic material ring is a pulser ring, said ring including circumferentially alternating N and S pole pieces, said N-pole pieces and said S-pole pieces being magnetized at a predetermined pitch.

49. The seal apparatus of claim 41, wherein:
said outer ring includes a first cylindrical portion, said first cylindrical portion axially extending and including an axial inner edge;
said outer ring including a second ring-shaped plate portion, said second plate portion extending radially inward from said inner edge of said first cylindrical portion;
said magnetic sensor being disposed in said external member, said magnetic sensor being disposed adjacent to and not contacting said outer peripheral surface of said first cylindrical portion;
said first cylindrical portion extending towards and covering at least either of said external member or said sensor side connector, and said reinforcing member including an extension portion of said first cylindrical portion; and
said inner ring side seal ring including a second cylindrical portion axially extending and radially opposing said first cylindrical portion;
said inner ring side seal ring includes a second ring-shaped plate portion extending radially outward from an outer edge portion in an axial direction of said second cylindrical portion and axially opposing to said first ring-shaped plate portion; and
said pulser ring is attached to an inner surface of said second ring-shaped plate portion and radially opposing said magnetic sensor.

50. The seal apparatus of claim 41, wherein:
said pulser ring is magnetized at a predetermined pitch, said pulser ring including circumferentially alternating N-pole pieces and S-pole pieces; and
said magnetic sensor comprising first and second magnetic detection portions spaced circumferentially apart from each other at a predetermined distance, said magnetic detection portions both producing rectangular wave signals, said wave signals being phases shifted from each other by 90 degrees, and said interval between them being ¼ of said pitch.

51. A rolling bearing apparatus for vehicles, comprising:
an outer ring member is fixed to a vehicle body;
an inner ring member being disposed concentrically with said outer ring member;
a plurality of rolling members being rotatably disposed against said outer ring member and said inner ring member;
an outer ring side seal ring being fixed to said outer ring member;
an inner ring side seal ring that, with said outer ring side seal ring, defines a seal apparatus, said inner ring side seal ring being fixed to said inner ring member;
a magnetic sensor being disposed at said outer ring side seal ring;
an external member resin-molding said magnetic sensor adjacent to said outer ring side seal ring;
a sensor side connector including two ends, said first end being formed with said external member and said second end being attachably connected to a wire harness side connector;
a reinforcing member being coupled to either of said external member or said sensor side connector, said reinforcing member reinforcing said sensor side connector; and
a pulser ring that, with said magnetic sensor, defines a rotation detector, said ring being fixed to a side of said inner ring side seal ring.

52. The rolling bearing apparatus of claim 51, wherein:
one end of said external member resin-molding said sensor adjacent to said outer ring side seal ring, and an other end thereof extending radially outward; and
said reinforcing member including an extension portion of said outer ring side seal ring, said extension portion extending extends towards and covers a back face of said external member.

53. The rolling bearing apparatus of claim 52, wherein:
said other end of said sensor side connector extends radially outward; and
said reinforcing member includes said extension portion of said outer ring side seal ring.

54. The rolling bearing apparatus of claim 51, wherein:
said other end of said external member is ring shaped and extends radially outward;
one end of said sensor side connector being integrally formed at said other end side of said extension of said external member and another end being cylindrically shaped and extending further radially outward than said other end of said external member;
said reinforcing member including a ring-shaped reinforcing member, said ring-shaped member including a first extension portion of said outer ring side seal ring, said first extension portion extending along and covering a back face of said other end of said external member;
said reinforcing member including a semi-cylindrical reinforcing member, said semi-cylindrical member including a second extension portion of said outer ring side seal ring, said second extension portion extending along and covering a surface of said other end of said sensor side connector.

55. The rolling bearing apparatus of claim 51, further comprising a contact surface, said contact surface contacting an outer peripheral surface of said outer ring member, said contact surface being disposed at said sensor side connector.

56. The rolling bearing apparatus of claim 51, wherein said external member comprises a ring-shaped contact surface, said ring-shaped surface axially contacting an end face of said outer ring member for to positioning said seal apparatus.

57. The rolling bearing apparatus of claim 51, wherein:
said magnetic sensor includes two magnetic detection portions, said magnetic portion being disposed circumferentially apart from each other;
a phase relationship between detection signals from said magnetic detection portions being set such that when one magnetic detection portion produces a first signal, the other magnetic detection portion produces a second signal that is phase shifted from said first signal by 90 degrees;
said pulser ring including circumferentially alternating N-pole and S-pole pieces that are magnetized at a predetermined pitch; and
a phase difference between respective outputs from both said magnetic detection portions being fÉ/4 relative to said magnetized pitch of said pulser ring poles.

58. The rolling bearing apparatus of claim 51, wherein:
said outer ring side seal ring includes a first cylindrical portion, said first cylindrical portion axially extending, and a second ring-shaped plate portion extending radially inwardly from an inner edge portion in said axial direction of said first cylindrical portion;
said magnetic sensor being resin-molded in said external member and being disposed adjacent to, and in a non-contact manner with, an outer peripheral surface of said first cylindrical portion;
said first cylindrical portion extending to and covering either of said external member or said sensor side connector;
said reinforcing member including an extension portion of said first cylindrical portion;
said inner ring side seal ring including a second cylindrical portion, said second cylindrical portion axially extending and radially opposing said first cylindrical portion;
said inner ring side seal ring including a second ring-shaped plate portion that extends radially outward from an outer edge portion in said axial direction of said second cylindrical portion, said second ring-shaped plate portion axially opposing said first ring-shaped plate portion; and
said pulser ring connecting to an inner surface of said second ring-shaped plate portion and radially opposing said magnetic sensor.

59. The rolling bearing apparatus of claim 51, wherein:
said vehicle body side comprises a cutaway through which said sensor side connector penetrates; and
said sensor side connector being inserted into said cutaway so that said outer ring member being fixed to said vehicle body.

60. The rolling bearing apparatus of claim 51, wherein:
said inner ring member includes a hub wheel that includes a flange portion for wheel attachment at an outer peripheral surface on said vehicle outward side;
said inner ring member including an inner ring, said inner ring being outwardly connected to a vehicle inward side cylindrical minor diameter portion of said hub wheel; and
said inner ring side seal ring being fixed to said inner ring.
